(19) United States
(12) Patent Application Publication
(10) Pub. No.: US 2020/0227926 A1
(43) Pub. Date: Jul. 16, 2020

(54) REMOTE CONNECTIVITY USING A BATTERY

(71) Applicant: Industrial Scientific Corporation, Pittsburgh, PA (US)

(72) Inventors: Lisa McCracken, Oakdale, PA (US); Benjamin Haas, Monaca, PA (US); Jonathan Eric Dinsmore, Aliquippa, PA (US); Raghu Arunachalam, Pittsburgh, PA (US)

(21) Appl. No.: 16/729,590

(22) Filed: Dec. 30, 2019

Related U.S. Application Data
(60) Provisional application No. 62/792,178, filed on Jan. 14, 2019.

(51) Int. Cl. H02J 7/00; H04L 29/08; H04Q 9/00; H02J 13/00

(52) U.S. Cl. CPC H02J 7/00032; H04L 67/12; H04Q 9/00; G01D 7/00; H02J 13/00002; H04Q 2209/823; H02J 13/00006

(57) ABSTRACT

The present disclosure describes a method for communicating sensor data to a remote server, the method according to one disclosed non-limiting embodiment of the present disclosure can include transferring network credentials to a sensing device, inserting a new battery into the sensing device, transferring the network credentials from the sensing device to the new battery, transferring a subset of data from one or more sensors of the sensing device to the new battery, establishing communications with a remote server using the network credentials, and sending the subset of data to the remote server.

### CLAIM TO PRIORITY

This application claims the benefit of the following applications, each of which is hereby incorporated by reference in its entirety: U.S. Ser. No. 62/792,178, filed Jan. 14, 2019 (ISCI-0046-P01).

### BACKGROUND

### Field

This disclosure relates to a battery for a sensing device, wherein the battery has communication capabilities that provides new network connectivity to the sensing device.

### Description of the Related Art

There remains a need for an easy way to enable existing sensing devices that currently lack communications capabilities or a particular type of communications capability to communicate data to a remote server.

### SUMMARY

The present disclosure describes a battery for providing new network connectivity. The battery according to one disclosed non-limiting embodiment of the present disclosure can include a power source; a power port structured to provide power to a sensing device; a data port structured to transmit data and receive data from the sensing device; a battery processing unit structured to receive sensor data and network credentials from the sensing device; and a communications module, the communications module structured to establish a network connection with a remote server using the network credentials and transfer the received sensor data to the remote server. The communications module may be further structured to interpret a data transmission schedule for transferring the data to the remote server. The data transmission schedule may include rules for transmitting data based on a priority of the data. The data transmission schedule may include rules for transmitting data based on values of data obtained from the sensing device. The battery may also include a location module structured to determine a location data associated with the battery, and wherein the location data may be appended to the data that is transferred to the remote server.

The present disclosure describes a method for transmitting data using a battery. The method according to one disclosed non-limiting embodiment of the present disclosure can include configuring a battery data port for general communication; probing the battery data port to initiate a response from the battery coupled to the battery data port; determining, from the response, that the battery includes at least one hardware module communicatively coupled to the battery data port; identifying that the at least one hardware module comprises a communication module based on the response; and transmitting the data to the communication module using the battery data port. The method may further include determining network credentials; and transferring the network credentials to the battery. The method may also include establishing a communication session with a remote server using the network credentials and the communication module. The method may further include determining at least one sensor reading; determining a priority of the at least one sensor reading; transferring the at least one sensor reading and the priority of the at least one sensor reading to the battery; determining, using the communication module of the battery, a data transmission schedule for the at least one sensor reading based at least in part on at least one rule associated with the priority of the at least one sensor reading; and transmitting the at least one sensor reading to the remote server. In some embodiments, the method may also include determining an alarm condition based on the at least one sensor reading; transferring the alarm condition to the battery; modifying the data transmission schedule to an alarm data transmission schedule, and transmitting, using the alarm data transmission schedule, at least one of the alarm condition and the at least one sensor reading to the remote server. In some embodiments, the alarm data transmission schedule may be configured to transmit the data at a faster rate than the data transmission schedule. The method may further include modifying the alarm data transmission schedule to the data transmission schedule after a first time period. The first time period may be a predetermined time period since the alarm condition was determined. The first time period may be a predetermined time period after no alarm conditions are determined. The method may further include determining at least one sensor reading; transferring the at least one sensor reading to the battery; determining a priority of the at least one sensor reading using the battery; determining, using the communication module of the battery, a data transmission schedule for the at least one sensor reading based at least in part on at least one rule associated with the priority of the at least one sensor reading; and transmitting the at least one sensor reading to the remote server. The method may further include determining at least one sensor reading; determining a priority of the at least one sensor reading using the battery; determining a data transmission schedule for the at least one sensor reading based at least in part on at least one rule associated with the priority of the at least one sensor reading; transferring the data transmission schedule for the at least one sensor reading to the battery; and transmitting, by the battery, the at least one sensor reading to the remote server according to the data transmission schedule. The priority of the at least one sensor reading may be based at least in part on a value of the at least one sensor reading and/or a source of the at least one sensor reading. The method may further include reconfiguring characteristics of outputs of the battery for communication with the battery data ports. The method may further include receiving, from the remote server, updated rules; and updating the data transmission schedule of the battery based on the updated rules. The method may further include appending a location data to the data transmitted to the remote server, wherein the location data is determined by a location circuit of the battery.

The present disclosure describes a system for providing new network connectivity to a sensing device. The system according to one disclosed non-limiting embodiment of the present disclosure can include a sensing device that a battery compartment structured to receive a power source, the battery compartment may include: a battery interface structured to receive data from the power source and a power connection to receive power; and one or more sensors. The system may further include a battery that includes the power source; a battery processing unit structured to receive sensor data and network credentials from the sensing device; and a communications module, the communications module structured to establish a network connection with a remote server using the network credentials and transfer the received sensor data to the remote server, wherein the battery may be configured to fit into the battery compartment of the sensing device. The communications module may be further structured to interpret a data transmission schedule for transferring data to the remote server. The data transmission schedule may include rules for transmitting data based on a priority of the data. The data transmission schedule may include rules for transmitting data based on values of data obtained from the one or more sensors. The system may include a location module structured to determine a location data associated with the battery, and wherein the location data may be appended to the received sensor data that is transferred to the remote server.

The present disclosure describes a non-transitory computer readable medium containing executable instructions that, when executed by a processor, cause the processor to transmit data using a battery by: configuring a battery data port for general communication; probing battery data port to initiate a response from the battery coupled to the battery data port; determining, from the response, that the battery includes at least one hardware module communicatively coupled to the battery data port; identifying that the at least one hardware module comprises a communication module based on the response; and transmitting data to the communication module using the battery data port. The instruction may include instructions for determining network credentials; and transferring the network credentials to the battery. The instruction may include instructions establishing a communication session with a remote server using the network credentials and the communication module. The instruction may include instructions for determining at least one sensor reading; determining a priority of the at least one sensor reading; transferring the at least one sensor reading and the priority of the at least one sensor reading to the battery; determining, using the communication module of the battery, a transmission schedule for the at least one sensor reading based at least in part on at least one rule associated with the priority of the at least one sensor reading; and transmitting the at least one sensor reading to the remote server. The instruction may include instructions for determining an alarm condition based on the at least one sensor reading; transferring the alarm condition to the battery; modifying the transmission schedule to an alarm transmission schedule, and transmitting, using the alarm transmission schedule, at least one of the alarm condition and the at least one sensor reading to the remote server. The alarm transmission schedule may be configured to transmit data at a faster rate than the transmission schedule. The instruction may include instructions for modifying the alarm transmission schedule to the transmission schedule after a first time period. The first time period may be a predetermined time period since the alarm condition was determined. The first time period may be a predetermined time period after no alarm conditions are determined. The instruction may include instructions for determining at least one sensor reading; transferring the at least one sensor reading to the battery; determining a priority of the at least one sensor reading using the battery; determining, using the communication module of the battery, a transmission schedule for the at least one sensor reading based at least in part on at least one rule associated with the priority of the at least one sensor reading; and transmitting the at least one sensor reading to the remote server. The instruction may include instructions for determining at least one sensor reading; determining a priority of the at least one sensor reading using the battery; determining a data transmission schedule for the at least one sensor reading based at least in part on at least one rule associated with the priority of the at least one sensor reading; transferring the data transmission schedule for the at least one sensor reading to the battery; and transmitting, by the battery, the at least one sensor reading to the remote server according to the data transmission schedule. The priority of the at least one sensor reading may be based at least in part on a value of the at least one sensor reading and/or a source of the at least one sensor reading. The instruction may include instructions for reconfiguring characteristics of outputs of the battery for communication with the battery data port.

The present disclosure describes a method for transmitting data using a battery. The method according to one disclosed non-limiting embodiment of the present disclosure can include, receiving a probing request at a battery data port; generating a reply in response to the probing request, the reply identifying at least one hardware module communicatively coupled to the battery data port; receiving data at the battery data port; transmitting the data to the at least one hardware module; and processing the data using the at least one hardware module. The at least one hardware module may include a communication module and processing the data may include transmitting the data to a remote server. The method may further include receiving, at the battery data port, network credentials; and establishing a communication session with the remote server using the network credentials and the communication module. The at least one hardware module may include a location module structured to determine location data, and processing the data may include appending the location data to the data for transmission to the remote server. The method may further include receiving, at the battery data port, at least one sensor reading; determining, using the communication module, a priority of the at least one sensor reading; determining, using the communication module, a data transmission schedule for the at least one sensor reading based at least in part on at least one rule associated with the priority of the at least one sensor reading; and transmitting, using the communication module, the at least one sensor reading to the remote server. The method may further include determining an alarm condition based on the at least one sensor reading; modifying the data transmission schedule to an alarm data transmission schedule, and transmitting, using the alarm data transmission schedule, at least one of the alarm condition and the at least one sensor reading to the remote server. The alarm data transmission schedule may be configured to transmit data at a faster rate than the data transmission schedule. The method may further include modifying the alarm data transmission schedule to the data transmission schedule after a first time period. The first time period may be a predetermined time period since the alarm condition was determined. The first time period may be a predetermined time period after no alarm conditions are determined. The method may further include receiving, at the battery data port, at least one sensor reading and a priority associated with each of the at least one sensor reading; determining, using the communication module, a data transmission schedule for the at least one sensor reading based at least in part on at least one rule associated with the priority of the at least one sensor reading; and transmitting the at least one sensor reading to the remote server. The method may further include receiving, at the battery data port, at least one sensor reading and a data transmission schedule for the at least one sensor reading; and transmitting, using the communication module, the at least one sensor reading to the remote server according to the data transmission schedule. The method may also include receiving, from the remote server, updated rules; and updating the data transmission schedule of the battery based on the updated rules.

The present disclosure describes a method for communicating sensor data to a remote server, the method according to one disclosed non-limiting embodiment of the present disclosure can include transferring network credentials to a sensing device, inserting a retrofit battery into the sensing device, transferring the network credentials from the sensing device to the retrofit battery, transferring a subset of data from one or more sensors of the sensing device to the retrofit battery, establishing communications with a remote server using the network credentials, and sending the subset of data to the remote server.

A further embodiment of any of the foregoing embodiments of the present disclosure may include situations wherein transferring network credentials is done using a connection selected from a list consisting of a docking station, an NFC connection, and a BLE connection.

A further embodiment of any of the foregoing embodiments of the present disclosure may further include establishing a rate of communications with the remote server

A further embodiment of any of the foregoing embodiments of the present disclosure may further include changing a rate of communication-based on the subset of data from the one or more sensors

The present disclosure describes a system for providing new network connectivity to a sensing device, the system according to one disclosed non-limiting embodiment of the present disclosure can include a sensing device including: a battery compartment configured to receive a power source, the battery compartment including: a battery interface configured to receive data from the power source and a power connection to receive power, and one or more sensors, and a retrofit battery, the retrofit battery including: a power source, a location module, a battery processing unit configured to receive sensor data and network credentials from the sensing device, a communications module, the communications module configured to establish a network connection with a remote server using the network credentials and transfer the received sensor data to the remote server, wherein the retrofit battery is formed to fit into the battery compartment of the sensing device.

These and other systems, methods, objects, features, and advantages of the present disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The disclosure and the following detailed description of certain embodiments thereof may be understood by reference to the following figures:

FIG. 1 depicts a schematic of an embodiment of a sensing device.

FIG. 2 depicts a schematic of an embodiment of a device with a retrofit battery.

FIG. 3 depicts a schematic of an embodiment of a battery with a communication routing circuit.

FIG. 4 depicts a schematic of an embodiment of a battery.

FIG. 5 depicts a data flow from a sensing device through a battery to a remote server.

FIG. 6 depicts an embodiment of a process of communicating data from a sensing device to a remote system.

FIG. 7 depicts an embodiment of a process of communicating data with network credentials from a sensing device to a remote system.

FIG. 8 depicts a method of communicating data from a sensing device to a remote system.

### DETAILED DESCRIPTION

The functionality of devices may be extended with hardware modules. Hardware modules may be added to devices to provide new functionality and/or restore functionality that was lost due to damage or malfunction. Additional hardware modules may be added to devices by repurposing power and/or data ports that are normally associated or assigned to batteries of a device. A typical, or normal, battery of a device may be replaced with a battery (also referred to herein as a retrofit battery or a new battery) that may include hardware modules (also referred to herein as additional hardware modules, or new hardware modules). The hardware modules included with the battery may use data ports of the device that were conventionally used for normal battery communication or diagnostics to communicate with the device.

In some embodiments, a device may lack a desired capability. The devices may be legacy devices which were deployed or designed before a specific capability was required for the device. The capability of devices may be extended or corrected with an additional hardware module. Additional hardware modules may be circuits or other hardware. Additional hardware modules may be programmable processors or reconfigurable circuits. An additional hardware module may be added to a device to extend the capabilities of a device. In some cases, a device may include data ports and mounting locations for adding external hardware modules. In some embodiments, a device may be designed or configured for additional modules that may be used to extend the functionality of the device.

However, in some cases, an additional hardware module may not be easily added to a device. A device may not have been designed or originally configured for extension of functionality using additional hardware. In some cases, a device may not include external communication and/or power ports allowing integration of additional hardware. In some cases, additional modules or hardware may not be added due to restrictions on the size constraints of the device, the environmental location of the device, and the like. For example, a device may be deployed in an environment with tight space constraints where there is no room for an additional communication module to be added to the outside of the device.

In embodiments, a normal, or typical, battery of a device may be replaced with a battery that provides additional functionality to the device. The normal, or typical, battery, as referred to herein, is a battery without additional hardware modules. The battery may include a power source and battery circuitry that provide the same, similar, or equivalent functionality to the normal battery. The battery may further include one or more additional hardware modules for extending the functionality of a device.

In embodiments, the battery may be installed in the same or similar manner as a normal battery. The power ports and/or data ports of the battery may connect to the power ports and/or data ports of the device. The device may receive power from the battery via the power ports. The device may transmit to and/or receive data from the battery via the data ports. The data ports may be used to transmit data between the device, battery circuit, and the hardware modules included in the battery.

For example, some models of devices may lack communication capability. The devices may be legacy devices which were deployed or designed before a communication capability was required for the device. In some cases, devices may include a communication capability, but one or more hardware components required for the communication may be faulty and/or not performing to specification or requirements. In some embodiments, a device may not include the required or desired type of communication capability. For example, a device may include a wired communication capability; however, a wireless communication capability may be required or desired for some applications or locations.

A normal battery of a device, which may lack communication capability, may be replaced with a new battery that provides new network connectivity to the device. The new battery may include a power source and one or more hardware modules for extending the capabilities of the device. The hardware modules of the battery may include a communication module for wireless communication with another device such as a server, a base station, a computer, a cloud device, internet of things system, and the like. The device may transmit data to the communication module of the battery, and the battery may transfer the data to other devices or systems.

The battery may be used to provide new network connectivity to a legacy device for which new connectivity may be otherwise difficult or impractical to implement. Using the systems, devices, and methods described herein, new network connectivity may be added to a device by simply replacing the normal battery with a new battery. The new battery may include new capabilities such as new network connectivity. Using the systems, devices, and methods described herein, new capabilities may be added to a device without requiring specialized training, calibration, certification, and/or without requiring prolonged downtime of the device.

The benefit of such an easy method of including a new capability may be illustrated with examples. In one example, a legacy device that does not include a communication capability may be positioned in an environment that may be hazardous or difficult to access. Traditionally, to include a communication capability in a hazardous environment, a legacy device may be replaced with a new device, or the legacy device may be removed from its location and upgraded offsite. Replacing a device in a hazardous environment may require specialized equipment, specialized worker training, and lengthy procedures to ensure worker safety during the replacement. Upgrading a device offsite may result in prolonged downtime. Using the systems, devices, and methods described herein, the problems of the traditional devices, systems and methods may be avoided. A legacy device may be upgraded to include new network connectivity or another new capability by changing the battery of the device from the normal battery to a new battery that includes hardware modules. New network connectivity may be added to a legacy device without replacing the device and without taking the device offsite for upgrades by replacing the normal battery with a new battery. Changing the battery of the device may be a quick process that does not require specialized training or procedures, thereby reducing the cost of the upgrade and the downtime of the device. Changing a normal battery of the device to a new battery may, in some embodiments, not require any tools or require simple tools and minimal training.

In another example, a legacy device that does not include a communication capability may be integrated with the environment such that replacing the device may require lengthy calibration or certification procedures. A legacy device may be a sensor device with sensors such as gas sensors or strain gauge sensors that may be integrated into a structure and/or may be calibrated or certified for a specific location or use scenario. If a device is replaced or removed, the new device may require recalibration and recertification which may involve lengthy and costly inspection and testing. Using the systems, devices, and methods described herein, the problems of the legacy device, systems, and methods may be avoided. A legacy device may be upgraded to include new network connectivity or other new capabilities by changing the battery of the device from the normal battery to a new battery with hardware modules. Changing the battery of the device may, in some embodiments, be a quick process that does not require removal of the device and may avoid recalibration or recertification of the device.

The addition of new network connectivity to a legacy device may have several benefits for many applications. In some devices without a network connectivity, data associated with the device is logged or stored in memory of the device. Access to the data may require a person to be present at the physical location of the device to download or access the data stored at the device. New network connectivity may enable remote data collection from a device. With network connectivity, data may be obtained in real-time or at a predefined schedule, which would be impossible or impractical without network connectivity. New network connectivity may enable devices to be configured, monitored, and/or upgraded remotely, reducing time and costs.

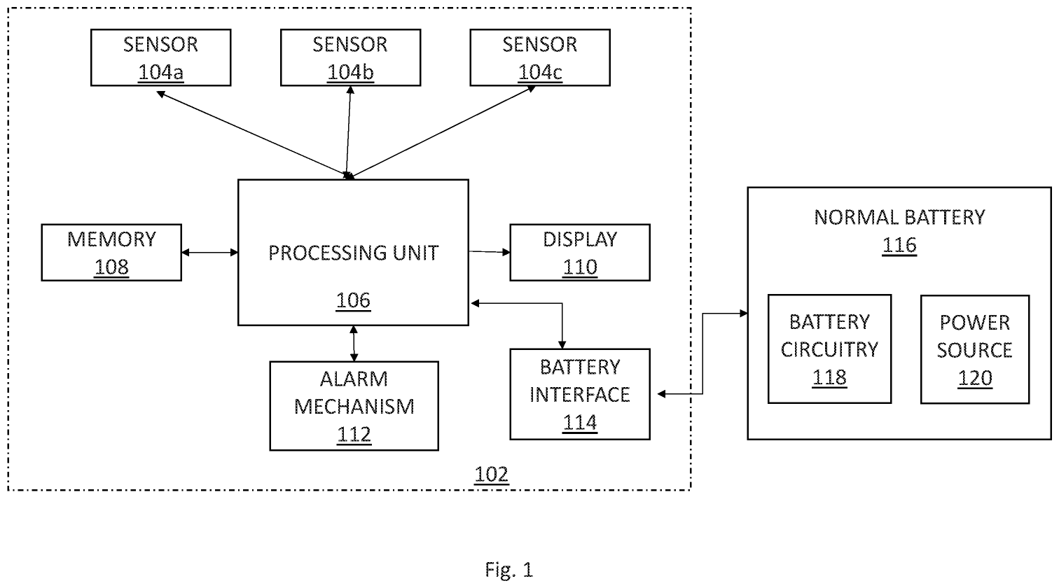

FIG. 1 depicts a device 102 which may be a sensing device. The device 102 may include one or more sensors 104a, 104b, 104c, a processing unit 106, a memory 108, an optional display 110 and one or more optional alarm mechanisms 112. The device 102 may also include a battery interface 114 for receiving power to be supplied to the device components. The battery interface may also include a peripheral interface.

In some embodiments, the battery interface 114 may be connected to a normal battery 116. A device 102 may be directly powered by the normal battery 116. In some embodiments, the normal battery 116 may be a source of backup power, and the device may be powered from other sources such as the mains/grid power, solar, other batteries, and the like. In some embodiments, the normal battery may be integrated into the device or may be removable and/or easily accessible.

In many embodiments, a normal battery 116 may include a battery circuitry 118 and a power source 120. The battery circuit 118 may include a feedback channel which provides the device 102 with information about the normal battery. The battery may, in addition to power, provide information regarding the status of the normal battery, such as temperature, charge status, and/or other parameters of the normal battery. The device may provide data to the normal battery regarding its power requirements, power settings, and the like. The feedback channel may be a unidirectional or bidirectional communication channel between the normal battery and the device. The battery interface 114 of the device may provide a communication interface for the feedback channel to the normal battery.

A feedback channel may be provided via a direct connection with one or more terminals that connect the normal battery 116 and the device 102. The terminals may include connections, connectors, pads, spring-loaded contacts, and the like. In some embodiments, a feedback channel may be provided with a short-range wireless communication interface between the device and the battery, such as Bluetooth, ANT, near field communication (NFC), and the like.

The normal battery 116 and the device 102 may be electrically coupled via one or more ports. The ports may include ports for power. Power ports may include at least one positive terminal and a negative terminal. The ports may provide direct current (DC) power, which may be 3V or 5V, or 20V or more. Ports may optionally include data ports. Data ports may be an additional terminal for transferring data between the device and the normal battery. In some embodiments, the data ports include one or more terminals for serial or parallel data transfer. In some embodiments, the data ports may be implemented on the same physical terminals as the power ports.

In some embodiments, the feedback channel may include Serial Peripheral Interface (SPI), a Synchronous Serial Interface (SSI), or other serial or parallel communication interfaces that use one or more data ports between the normal battery and the device. In some embodiments, the feedback channel between a device and a normal battery may include communication over the power ports.

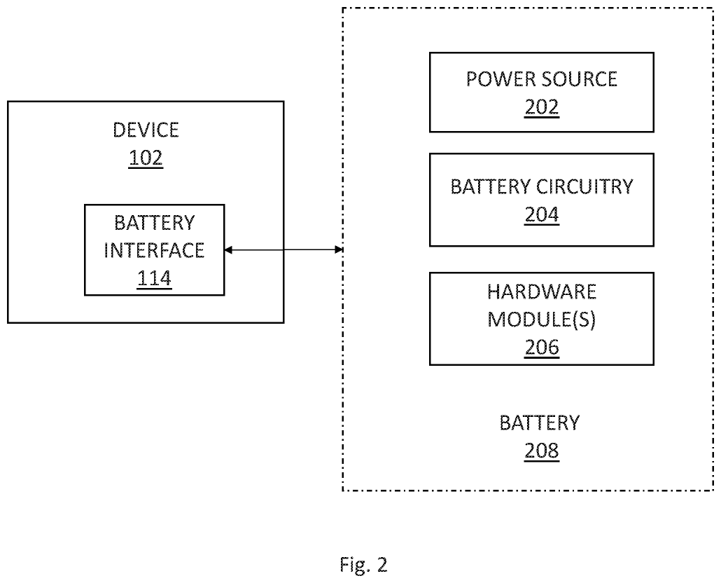

FIG. 2 depicts a battery 208 that may be connected to the device 102 via the battery interface 114 of the device. The battery 208 may include one or more power sources 202, battery circuitry 204, and one or more hardware modules 206 for extending the functionality of the device 102. The battery may connect to the device using the same battery power ports and data ports that the normal battery.

Hardware modules 206 may be integrated into and/or with the power source 202 of the battery 208. Hardware modules 206 may be packaged in the same enclosure as the power source 202. In some embodiments, hardware modules 206 in the battery may be provided in the same package as the power source of the battery but may be separated from the power source of the battery. The hardware modules and the power source of the battery may be separated by one or more separate containers, membranes, coatings, and the like. In some embodiments, the power source 202 and the hardware modules 206 may be separated with one or more thermal and/or electrical insulators. In some embodiments, the battery circuitry 204 that is used to control, maintain, and/or charge the power source of the battery may be part of or at least partially integrated with the hardware. The hardware and battery circuits may share the same printed circuit board, processors, memory, and/or the like. In some embodiments, the battery circuits and the hardware may be separate such that they are implemented on separate circuit boards, processors, memory, and/or the like.

In embodiments, the power source 120 of the normal battery and the power source 202 of the battery may be based on the same or different battery chemistries or technologies. A battery power source may include one or more wet or dry cells and may be based on lithium, lithium-ion, alkaline, cadmium, zinc, lead-acid, magnesium, and other chemistries. Each type of battery may require different battery circuits to maintain, charge, and/or control the battery. Different battery circuits may require different feedback information from the device. The battery may have a different capacity than the normal battery. In some embodiments, space or volume of the hardware modules may require a smaller battery capacity in the battery compared to the normal battery.

In embodiments, the battery may include one or more electrical connections between the power source 202, battery circuit 204, and the hardware module 206 in the battery 208. Electrical connections may include connections that provide power from the power source 202 to the hardware modules 206. Hardware modules may be powered by the power source 202 of the battery 208. Hardware modules 206 of the battery may include one more circuits to increase and/or decrease the voltage provided by the power source 202. Circuits may include one or more DC to DC power converters, charge pumps, inverters, and the like to modify the voltage of the input power to make the voltage and or current suitable for the power modules 206. Electrical connections may include connections for controlling or monitoring the battery circuit. The additional hardware may directly or indirectly receive information from the battery circuit regarding the status of the power source, power level, temperature, and the like. In some embodiments, the hardware module 206 may be configured to directly send commands to the battery circuit 204.

In embodiments, the battery may be packaged and configured such that the battery provides the same external interface as that of the normal battery. The power ports and/or data ports may be arranged in the same positions with the same number of ports and electrical interfaces as the normal battery. A device 102 may receive power from the battery 208 via the power ports. A device 102 may transmit to and receive data from the battery using data ports between the device 102 and the battery 208.

In embodiments, the device may require reprogramming and/or update in software and/or firmware to send data to the battery. Typically, when a normal battery is present, the device may be configured to transmit and receive battery or power-related data at the peripheral interface of the normal battery. The device may be reconfigured or enabled to send and receive additional data that is not directly related to the power or battery functions of the device. The battery data ports may be reconfigured for general communication. General communication may include additional data transfer that is unrelated to the battery power related data. The device may be reconfigured or enabled to send and receive additional data related to sensor readings of the device. In embodiments, the device may be reprogrammed and/or updated to utilize the data ports between the device and the battery to communicate with one or more of the hardware modules of the battery.

In embodiments, data received at the data ports of the battery may be directly transmitted to both the battery circuit and the hardware module. In embodiments, the battery circuitry and the hardware module of the battery may be configured to recognize aspects of the data to determine if the data is directed to one or more of the hardware modules or the battery circuit. In embodiments, the battery circuit and the hardware modules may detect specific headers, prefixes, addresses, and the like to determine if data received at the communication port of the battery is intended for a specific circuit or module. When a specific header, prefix, address, and the like is detected by the battery circuit or the hardware module the data may be processed by the respective circuit or module. Similarly, when the battery circuit or the hardware transmits data to the device, the circuit and/or hardware not involved in the communication may be configured to ignore the transmitted data.

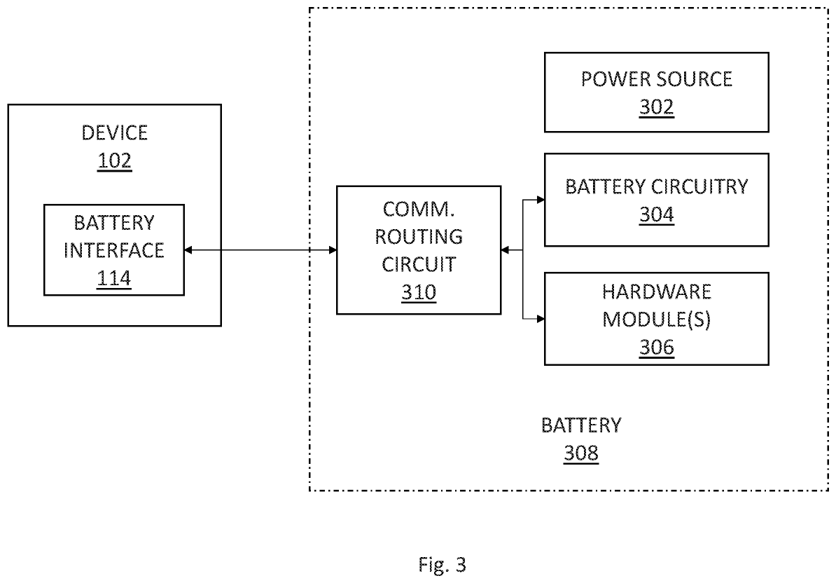

In embodiments, the battery may include a communication routing circuit that interfaces the data ports of the battery with the battery circuit and the one or more hardware modules. FIG. 3 depicts an embodiment of a battery 308 with a communication routing circuit 310. The communication routing circuit 310 may monitor the data received from the device 102 at the data port and determine which part, circuit, or module of the battery the data is intended for. The communication routing circuit may detect specific headers, prefixes, addresses, and the like to determine for what part, circuit, or module of the battery the data that was received by the battery is intended for. The communication routing circuit may use one or more parallel lines, multiplexers, and other routing techniques and hardware to route the received data to the appropriate part of the battery, such as one or more hardware modules 306 or the battery circuit 304.

In embodiments, the communication routing circuit 310 may have different communication interfaces at the communication ports of the battery than the interface inside the battery between parts of the battery. For example, at the data ports of the battery 308, the communication routing circuit 310 may provide a serial communication interface while the inside the battery, communication between the communication routing circuit 310 and other parts of the battery may use a parallel communication interface. In embodiments, the voltage, timing, protocol, and the like of the communication interface inside the battery and at the data ports of the battery may be different and may be converted by the communication routing circuit 310.

In embodiments, the communication routing circuit may be configurable. The voltage, protocol, timing, signaling conventions, frequency, baud rate, and the like that are generated by the communication routing circuit at the data ports of the battery may be selectable or programmable. The battery may be configured for specific parameters and characteristics of the communication between the battery and the device. The specific communication characteristics may be based on the capabilities of the device. The configurability of the output interface may allow the battery to be integrated or adapted to various devices which may have different communication interface requirements. The internal communication interface between the communication routing circuit and internal components of the battery may be constant and not affected by the selection of the communication interface at the communication ports of the battery. For example, the communication interface circuit may be configurable such that the battery may receive and or transmit data using an SPI or SSI interface.

In embodiments, the communication routing circuit may be automatically configured to match the data interface of the device that is provided by the battery interface of the device. The communication routing circuit may monitor the voltage and data characteristics of received data from the device. The communication routing circuit may auto-detect the type of interface provided by the device and configure its output data interface for the detected characteristics. For example, the communication routing circuit may detect the specific data packets associated with the SPI data interface and configure its output interface to the same SPI protocol.

In embodiments, the hardware modules of a battery may include any number of modules for extending the capabilities of the device. The hardware modules may include any number of hardware modules for communication, wireless communication, memory, location or positioning, orientation, relative position, adding additional external ports or interfaces, sensors, timers, processors and configurable hardware for processing data, external interfaces such lights speakers, and the like.

In embodiments the number, types, capabilities, and other characteristics of the hardware modules may be determined by the device by probing the battery using the battery data ports. In some embodiments, a device may send a request or a command for identification of the hardware modules in communication with the battery data ports. A request, or a probe, from the device may cause the individual hardware modules of the battery to identify their type, capabilities, and the like to the device. In some embodiments a battery type and/or the battery capabilities and hardware modules inside the battery may be identified by a serial number or an identification associated with the battery that may be transmitted to the device.

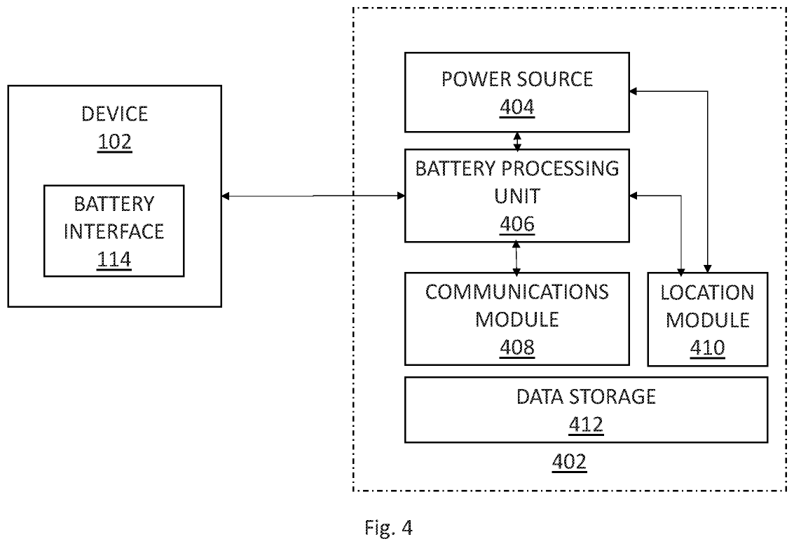

FIG. 4 depicts another embodiment of a battery 402, which may include hardware modules for enabling communication with a remote server. The battery 402 may be connected to the battery interface 114 and provide power to the device 102. The battery may be shaped to occupy the space of a normal battery of the sensing device 102 and provide the same interface to the sensing device 102. The battery 120 may include a power source 404, a battery processing unit 406, and one or more hardware modules such as a communications module 408, a GPS/Location module 410, and data storage 412.

The battery 402 may communicate with the device 102 by superimposing the data signal on the normal battery contacts used to transfer power. The superimposed data signal may employ amplitude and/or frequency modulation schemes. The battery processing unit 406 may include an SPI or the like for connecting with the battery interface 114. The battery 402 may communicate with the device 102 by using near field communication techniques and short-range wireless techniques such as Bluetooth, and the like. The communications module, battery processing unit, and location module may be on a single board or distributed across multiple boards.

The communications module 408 may support Wi-Fi and low-power wide-area (LPWA) communication protocols such as those designed for the Internet of Things (IoT) and machine-to-machine communications (M2M). Protocols may include LTE Cat M LTE CAT NB1, Sioux, Elensa, Nwave, NB-Fi Protocol, DASH 7, and the like. The data may be sent at intervals to preserve battery live. LTE Cat Mi, which operates using existing LTE cellular networks such as those of Verizon and AT&T, includes features such as low transmission power (20-23 dBm(milliwatts)), low latency (10-15 milliseconds) and limited data rates (˜1 Mbps) which may advantageous for reducing battery load given that the amount of data being transmitted at any given time may be relatively low.

The location module 410 may be based on a global navigation satellite system (GNSS), trilateration based on cell towers or Wi-Fi access points, the receipt of location information from a beacon, or the like.

Due to the nature of the environments in which the devices 102 may be deployed, the battery may be designed to meet hazardous environment design requirements as specified in industry standards (e.g. robustness to fall, potential to spark, limiting resistance requirements, limits on power in circuitry, limits on stored power, not to exceed temperatures, transmission power limitations, specified transmission frequencies, enclosure specifications, and the like)

In an embodiment, and as depicted in FIG. 1, the device 102 may be a sensing device and include one or more sensors 104. The sensors of the device may monitor one or more parameters of a mechanical component, electrical component, environmental conditions, ambient conditions, operating conditions, and the like. The sensors of the device may monitor, record, process, save, and/or communicate the sensor readings to one or more other devices or systems. In embodiments, the normal battery of the device may be replaced with a battery that may include one or more hardware modules, such as a wireless communication module. The device may use the interface that was normally used to communicate with the normal battery to communicate with the battery 402 and the communications module 408 of the battery 402, as depicted in FIG. 4. The device may use the communications module 408 of the battery 402 to transmit one or more sensor readings, processed results of sensor readings, processed outcomes related to sensor readings, and the like.

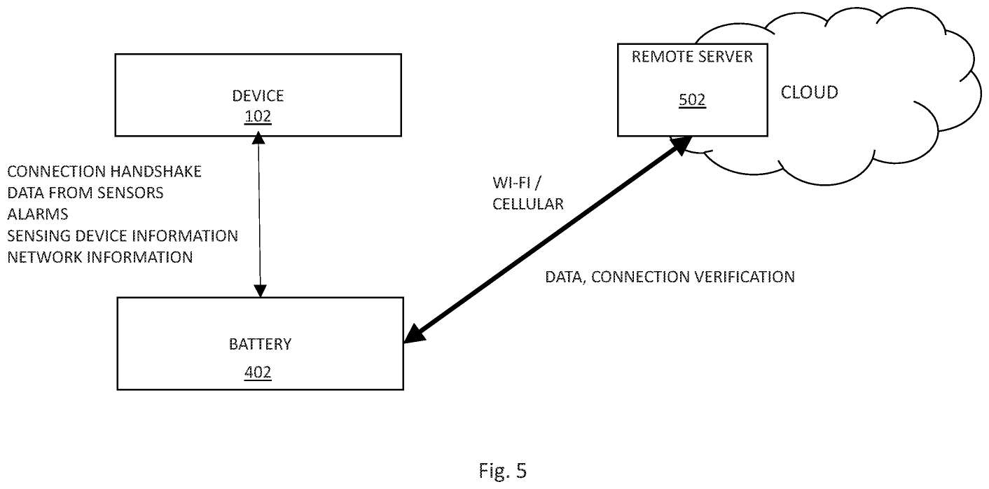

As depicted in FIG. 5, the device 102 may communicate with the battery 402 and may send the battery 402 data from sensors, alarms, information about the sensing device, interval at which the data is to be sent, information about the desired network connection, and the like. The battery 402 may then establish a connection with a remote server 502 in the cloud and relays the information from the sensing device together with location information provided by the battery 402 to the remote server 502. The connection with the remote server 502 may be established using a cellular or Wi-Fi connection. The connection with the remote server 502 may require a user identification and password credentials that may be supplied by the sensing device 102.

The device 102 may initiate a transfer of data related to the device to the battery 402 via the battery processing unit 406 using the battery interface 114. Data transferred to the battery 402 from the sensing device 102 may include the serial number of the device, the sensors installed on the sensing device, any alarms in effect on the sensing device (e.g. gas levels, man down, panic, proximity to an out of bounds area and the like), status of the device 102, status of one or more sensors of the device 102, battery status, pertinent data readings from the sensing device such as specific gas readings, temperature, humidity and the like. The data transferred to the battery 402 may also include any network identification/log in information for the data destination. The device 102 may determine the frequency with which data is shared with the battery 402 and the frequency with which the data is transmitted to the data destination. The rate may be set, for example, at an initial rate of once every minute. However, the device 102 may change the rate at which data is sent based on environmental conditions such as measured gas levels, presence of a specified gas, temperature out of range, whether the sensing device is an alarm condition, upon an update to the user or site name, and the like. The sensing device 102 may transfer data to a battery 402 upon an alarm or meeting specified conditions. After the initial transmission, the device may continue to send data at an altered, faster rate while the alarm conditions persist, gas levels are above a threshold, or the like. The battery 402 may repeat the transmission of alarm conditions, high gas levels, and the like until reset by the sensing device 102. The battery 402 may send location data without data from the device. The location data may be sent on a periodic basis or upon specific criteria such as a change in location or a low battery level. In embodiments, the battery may check for messages from the remote server periodically, but between data transmissions, the battery may go into a low power mode to extend battery life.

The sensing device may send data to the battery on a periodic basis where that basis is based on a balance of sharing data and operational run time for the sensing device. However, if there is an alarm condition or under certain conditions such as gas levels above a specified threshold, the data may be shared immediately and subsequently more frequently until the alarm or other conditions cease.

In embodiments, a battery may transmit data according to a data transmission schedule. However, when an alarm condition is detected, the transmission schedule may be changed to an alarm data transmission schedule. The alarm data transmission schedule may temporarily override transmission schedule when there are no alarm conditions detected. During an alarm data transmission schedule, data related to the alarm condition may be processed and sent to the remote server as soon as it is received. In some embodiments, during an alarm, data transmission schedule data may be transmitted at a faster rate or more frequently than for the data transmission schedule when no alarm conditions are detected. The alarm data transmission schedule may indicate that data should be transmitted to the remote server at least twice as frequently as when no alarm conditions are detected. In some embodiments, when an alarm condition is detected, all data from sensors may be transmitted using the alarm transmission schedule. In some embodiments, when an alarm conditions is detected, only the data that is directly related to the alarm condition may be sent using the alarm data transmission schedule. For example, if the alarm condition is caused by a high sensor reading, related data may include sensor readings of the sensor and additional sensors in proximity to the sensor that has detected the alarm condition. The sensor data from the sensor that caused the alarm condition and the related sensors may be sent using the alarm data transmission schedule.

In embodiments, the alarm data transmission schedule may be active for a limited time and may expire. After the alarm data transmission schedule expires, data may return to being transmitted using the data transmission schedule that was active before the alarm condition was detected. In some embodiments the alarm data transmission schedule may be active only as long as the alarm condition is detected. In some embodiments, the alarm data transmission schedule may be active for a predetermined time after the alarm condition is no longer detected. In some embodiments, the alarm data transmission schedule may be active for a predetermined time after the alarm condition is first detected and may expire after the predetermined time even if the alarm condition is still detected.

In embodiments, the frequency of data transmission of data by a battery with a communication capability may be determined by the priority of the data. The priority of data may be determined by the device and/or the battery. In embodiments, data may be labeled or tagged according to the importance and/or urgency of the data. Priority may be based on a scale from one through ten or a one through three or according to a grouping such as low or high priority. Data may be associated with a tag that specifies the priority of the data. In embodiments, the priority of data may dictate when data should be sent from the battery to a remote server. High priority data (such as data rated 10 or 9 on a 10-point scale) may be transmitted as soon as it is received or generated. Low priority data (such as rated 1 or 2 on a 10-point scale) may be accumulated and transmitted every couple of seconds, minutes, or hours in a batch of data. In embodiments, transmission rules based on the priority of data may dictate when the data will be transmitted to the remote server, the schedule of transmission, the power output of the transmitter during transmission, the protocol used in transmission, the number of times the data is transmitted, and the like.

In embodiments, the device may determine the priority of data before the data is communicated to the battery. The device may further determine a transmission schedule for the data. In embodiments, the device may communicate data to the communication module of the battery with an indication as to when the data should be transmitted. In this arrangement, the communication module of the battery may not directly receive the priority of the data.

In embodiments, the device may determine the priority of data before the data is communicated to the battery. The device may associate the data with a priority tag that the communication module in the battery may interpret to determine when and/or how the data should be transmitted. In embodiments, the priority may be communicated with an additional one or more bits that are appended to the data. The communication module of the battery may read the priority assigned to the data and determine when and/or how the data should be transmitted. In embodiments, the communications module of a battery may compare the received priority of each data and compare the priority to a table of priorities. The table may indicate when and how the data should be transmitted to the remote server.

In embodiments, the device may transmit data to the communications module of the battery. The communication module of the battery may determine the priority of the data. The priority of the data may be determined based on the values of the data. In the case where the data received by the communication module is related to sensor readings, the data may include a sensor identifier and a value of the sensed data. In embodiments, the communication module may include a table or other data structure to determine the priority of the data based on the value of the data and/or the source of the data. In embodiments, values of some sensor readings may cause the communication module to assign a high priority value to the data. In some embodiments, low values of some sensor readings may cause the communication module to assign a low priority value to the data. In some embodiments, the priority of the data may be assigned based on which sensor the data is associated with. For example, in some embodiments, the priority of readings from a temperature sensor may be proportional to the value of the temperature. Higher temperature values may signify that machinery is overheating and needs attention. Higher temperatures or temperatures that are above a predetermined threshold may signify that a piece of machinery needs immediate attention, and therefore, the temperature data may be assigned a high priority. In some embodiments, any data that originates from a specific sensor may correspond to an alarm or other error and may be assigned a high priority regardless of the value. For example, a gas sensor may only provide readings when a gas leak is detected. In such a case, any time a gas sensor is triggered to provide data, the data may be assigned a high priority. The assigned priority may dictate when and/or how the data is transmitted to the remote server.

The configuration in which the communications module of the battery determines the priority and when and/or how the data is transmitted may be advantageous in some situations. Such a configuration allows that the rules and data used to determine priority may be stored in a table that may be easily updated from the server without requiring sending data or modifying software or parameters of the device. In some embodiments, the software or parameters may be difficult to update remotely via data received from the battery. In some embodiments, it may be easier and/or faster to update the priority rules in the memory of the battery or the communication module of the battery.

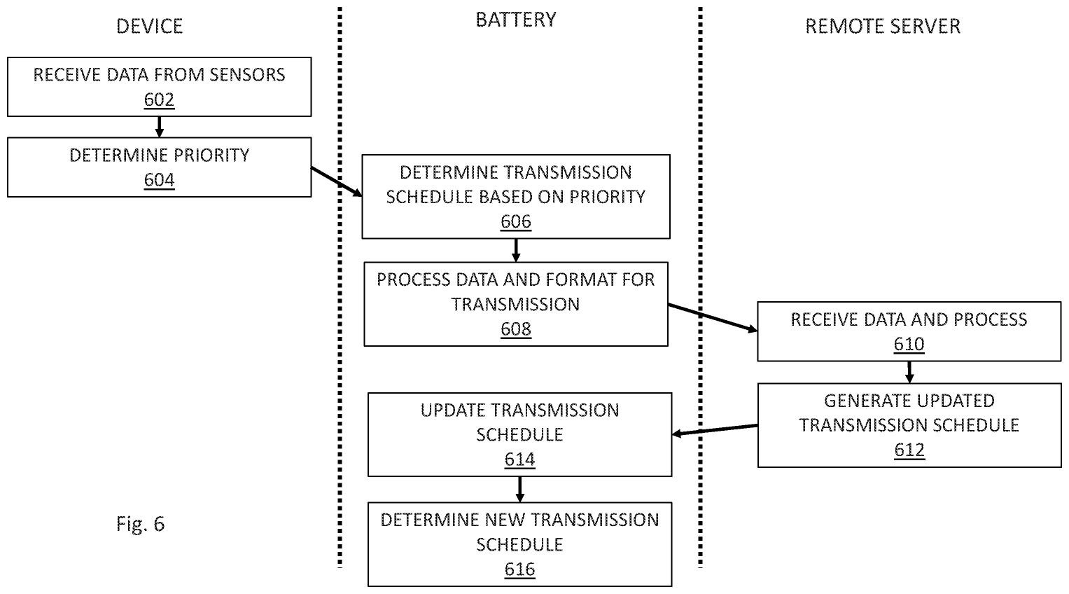

FIG. 6 depicts an embodiment of a process of communicating data from a sensing device to a remote system. In the embodiment, the device may determine the priority of the data. The process may start with the device receiving data 602. If the device is a sensor device, the data may include sensor data. The data may include the value of the sensor readings and an identifier of the sensor. The identifier may include the serial number of the sensor, the type of sensor, and the like. In some cases, a timestamp may be included with each sensor data that corresponds to the real or relative time the sensor reading was observed. In step 604, the device may determine the priority of the data. The priority may be determined based on the values of the data, the source of the data, and the like. The priority may be assigned to each sensor reading or a group of sensor readings that occurred with a specific time span. In some cases, one sensor reading value from a group of sensor values that is above a threshold may cause a whole group of sensor reading values to be associated with a high priority. The prioritized data may be sent to the battery.

In step 606, the battery may determine the transmission schedule of the received data based on the associated priority. In some cases, the received data may be a high priority and may be prepared and transmitted to the server as soon as it is received. Data may be stored in a buffer or local memory. For low priority data, the data may be buffered for a fixed time or until a specific number of data readings are received. In some embodiments, when data is not immediately sent, the communication module of the battery may be configured to enter a sleep mode to conserve battery power until the data is ready or scheduled to be transmitted. Data in the buffer may be processed out of order. For example, high priority data may be transmitted out of sequence as soon as it is received, even if low priority data was received by the battery. In step 608, the data may be formatted and transmitted to the remote server. The data may be packetized. In some cases, additional data from location modules may be added to the transmitted. The transmitted data may include the timestamp and priority associated with each reading or group of sensor readings.

In step 610, the server may receive the data and process, forward, or save the data as needed according to the rules for processing the data. In step 612, the server may optionally be configured to generate an updated transmission schedule. In some embodiments, user, input or change in operating procedures may cause an update as to the transmission schedule used to send data. The updated schedule may define rules of how data of different priorities should be transmitted. The rules may define how often data is sent, how many data are buffered, and the like. The updated transmission schedule may be transmitted to the battery. The battery may update the transmission schedule in memory of the battery in step 614, and the battery may determine a new transmission schedule based at least in part on the priority of data received from the device 616.

In embodiments, transmission between the battery and the remote server may require network credentials. Network credentials may identify the device and provide a method to authenticate the device. Network credentials may be used to ensure secure communication between the battery and the remote server. In some embodiments, the network credentials may be stored in the device. The network credentials may identify the device. In some embodiments, the network credentials may include a password or a security token used to authenticate the device to the remote server. The network credentials may be transmitted from the device to the battery. The communication module of the battery may store the credentials in temporary storage. The network credentials may be used each time a new communication session is established between the battery and the remote server. In some embodiments, each time the session is established, the credentials may be erased from temporary storage in the battery to prevent the storage of the credentials in the battery. In some embodiments, the battery may be configured to permanently store the received credentials or store them for a predetermined time. In some cases, the network credentials may be associated with an expiration time or expiration date, and new network credentials may be provided by the device to the battery when needed or requested. In embodiments, the communications module of the battery may include cryptographic functions and protocols such as public and/or private key encryption and other functions to prevent the network credentials being sent in cleartext.

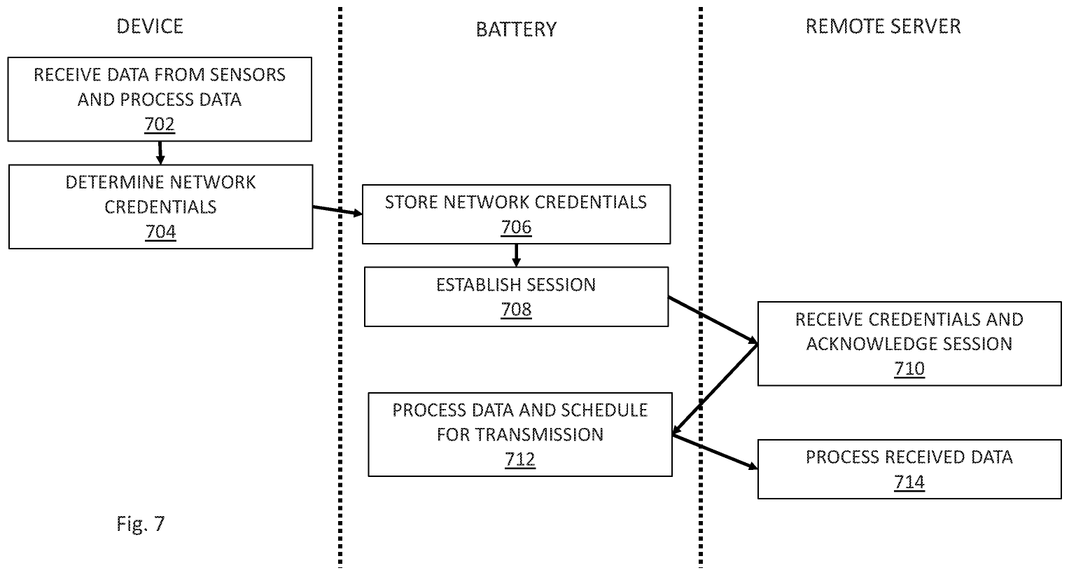

FIG. 7 depicts an embodiment of a process of communicating data with network credentials from a sensing device to a remote system. In embodiments, the process may start with the device receiving sensor readings from sensors 702 that are to be transmitted to the remote server. The data may be preprocessed, such as determining the priority of the data and the like. In step 704, the device may determine network credentials. The credentials may be static and may be a value that is stored at the device, which may uniquely identify the device. In some embodiments, the credentials may be dynamic and may change in time. One or more cryptographic functions and operations may be used to update a network credential in time from an initial value or seed. The network credentials may be transmitted to the battery. The battery may store the network credentials in local storage 706. The network credentials may be associated with an expiration date. In such cases, the battery may be configured to receive new network credentials each time the credentials expire. In some cases, the network credentials may be stored in temporary memory, which is cleared when the data is used. In step 708, the battery may use the credentials to establish a network session with the remote device. Establishing the session may include sending the network credentials to the remote server. In some cases, the network session may be established using encrypted communications. In step 710, the remote server may authenticate the device using the network credentials and establish the session. After the session is established, data may be transmitted from the battery to the remote server 712 and processed by the remote server 714.

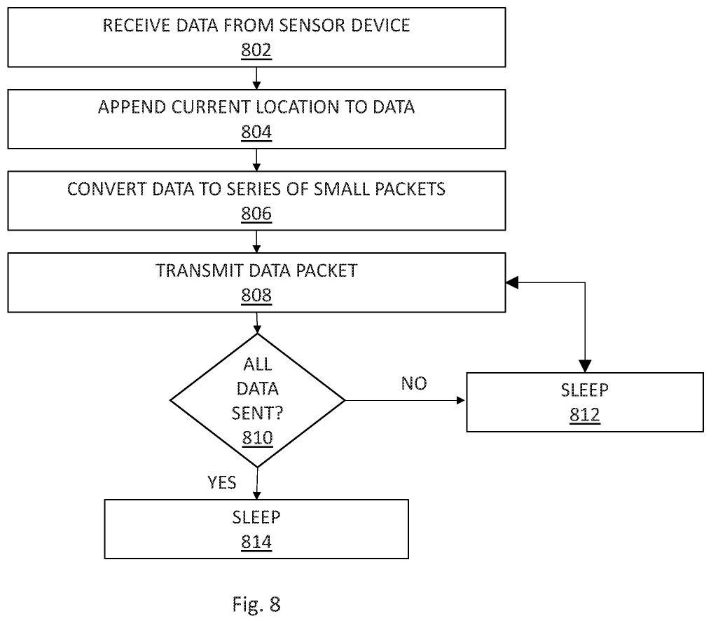

FIG. 8 depicts a method of communicating data from a device to a remote system. As shown in FIG. 8, upon receipt of data from the device (Step 802), the communications module 408 and/or battery processing unit 406 wakes up and appends the current location, provided by the location module 410, to the received data (Step 804). The data is then converted to a series of small data transmission packets (packetized) (Step 806). The communications module 406 may then initiate Wi-Fi or cellular transmission using low-power wide-area (LPWA) cellular communication protocols to provide the data to a remote server in the cloud and begin to transmit the data packets as a series of transmissions. The communications module 408 may transmit a data packet (Step 808) and then determine if all the data is sent (Step 810). If the data is all sent, the communications module 408 and the battery processing unit 406 may go to sleep for the first period of time (approximately 10-20 sec) (Step 812), after which the next data packet is transmitted (Step 808). If all the data has been sent, the communications module 408 and the battery processing unit 406 may go to sleep for the second period of time (˜1-2 minutes) (Step 814) or until new data is received from the sensor device (Step 802). If no new data is received before the elapse of the second time period, the communication module 408 may wake to establish a brief connection with a remote server to verify the current integrity of the connection. In some embodiments, the brief connection may include an “I'm OK” message, a location, and the like. In some embodiments, the brief connections may continue even if the sensing device is turned off. The periodic sending of location information may facilitate the location of the equipment even if the sensing device has been turned off. When not actively transmitting, the communications module may power down to extend battery life.

In some embodiments, the battery processing unit 406 may perform data processing such as consolidation, hazard critical determination, prioritization, identification of a portion of the data to be sent, and the like, prior to packaging the data for transmission. In some embodiments, the battery processing unit 406 may determine if a message has been received from the remote server and respond accordingly, e.g., pass the message to the sensing device, transmit location information, transmit battery status, and the like.

The battery may be designed to integrate easily with a client's existing infrastructure of docking stations, accessories, chargers, pumps, and the like. In order to use the battery as a way to transmit data directly from a specific device to a remote server in the cloud (using Wi-Fi or Cellular), the firmware in the specific sensing device may be upgraded to repurpose the use of an existing battery interface as an SPI interface. This may be done using existing docking stations, near field communications, or BLE communications. This enables the conversion of the sensing devices to leverage the new battery without the need to take the sensing devices out of operation for an extended period, such as to send them out for a hardware retrofit. The docking station, NFC communication connection, BLE connection, and the like may be used to provide, to the sensing device, network credentials such as network ID, user IDs, passwords, network security, encryption information and the like needed for the transmission of data to the remote server. The sensing device may then transfer the network credentials to the battery.

The methods and systems described herein may be deployed in part or in whole through a machine that executes computer software, program codes, and/or instructions on a processor. The processor may be part of a server, client, network infrastructure, mobile computing platform, stationary computing platform, or other computing platforms. A processor may be any kind of computational or processing device capable of executing program instructions, codes, binary instructions, and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable the execution of multiple programs, threads, and codes. The threads may be executed simultaneously to enhance the performance of the processor and to facilitate simultaneous operations of the application. By way of implementation, methods, program codes, program instructions, and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions, and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual-core processor, quad-core processors, other chip-level multiprocessors, and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server, and other variants such as a secondary server, host server, distributed server, and the like. The server may include one or more of memories, processors, computer-readable transitory and/or non-transitory media, storage media, ports (physical and virtual), communication devices, and interfaces capable of accessing other servers, clients, machines, and devices through a wired or a wireless medium, and the like. The methods, programs, or codes, as described herein and elsewhere may be executed by the server. In addition, other devices required for the execution of methods, as described in this application, may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of programs across the network. The networking of some or all of these devices may facilitate parallel processing of a program or method at one or more locations without deviating from the scope of the disclosure. In addition, all the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer-readable transitory and/or non-transitory media, storage media, ports (physical and virtual), communication devices, and interfaces capable of accessing other clients, servers, machines, and devices through a wired or a wireless medium, and the like. The methods, programs, or codes, as described herein and elsewhere may be executed by the client. In addition, other devices required for the execution of methods, as described in this application, may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of programs across the network. The networking of some or all of these devices may facilitate parallel processing of a program or method at one or more locations without deviating from the scope of the disclosure. In addition, all the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM, and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic book readers, music players, and the like. These devices may include, apart from other components, a storage medium such as flash memory, buffer, RAM, ROM, and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer-executable transitory and/or non-transitory media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software, or any combination of hardware and software suitable for a particular application. The hardware may include a dedicated computing device or specific computing device or a particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application-specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer-executable code may be created using a structured programming language such as C, an object-oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer-executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples but is to be understood in the broadest sense allowable by law.

1. A method for transmitting data using a battery, the method comprising:
configuring a battery data port for general communication;
probing the battery data port to initiate a response from the battery coupled to the battery data port;
determining, from the response, that the battery includes at least one hardware module communicatively coupled to the battery data port;
identifying that the at least one hardware module comprises a communication module based on the response; and
transmitting the data to the communication module using the battery data port.

2. The method of claim 1, further comprising:
determining network credentials; and
transferring the network credentials to the battery.

3. The method of claim 2, further comprising:
establishing a communication session with a remote server using the network credentials and the communication module.

4. The method of claim 3, further comprising:
determining at least one sensor reading;
determining a priority of the at least one sensor reading;
transferring the at least one sensor reading and the priority of the at least one sensor reading to the battery;
determining, using the communication module of the battery, a data transmission schedule for the at least one sensor reading based at least in part on at least one rule associated with the priority of the at least one sensor reading; and
transmitting the at least one sensor reading to the remote server.

5. The method of claim 4, further comprising:
determining an alarm condition based on the at least one sensor reading;
transferring the alarm condition to the battery;
modifying the data transmission schedule to an alarm data transmission schedule, and
transmitting, using the alarm data transmission schedule, at least one of the alarm condition and the at least one sensor reading to the remote server.

6. The method of claim 5, wherein the alarm data transmission schedule is configured to transmit the data at a faster rate than the data transmission schedule.

7. The method of claim 6, further comprising:
modifying the alarm data transmission schedule to the data transmission schedule after a first time period.

8. The method of claim 7, wherein the first time period is a predetermined time period since the alarm condition was determined.

9. The method of claim 7, wherein the first time period is a predetermined time period after no alarm conditions are determined.

10. The method of claim 3, further comprising:
determining at least one sensor reading;
transferring the at least one sensor reading to the battery;
determining a priority of the at least one sensor reading using the battery;
determining, using the communication module of the battery, a data transmission schedule for the at least one sensor reading based at least in part on at least one rule associated with the priority of the at least one sensor reading; and
transmitting the at least one sensor reading to the remote server.

11. The method of claim 3, further comprising:
determining at least one sensor reading;
determining a priority of the at least one sensor reading using the battery;
determining a data transmission schedule for the at least one sensor reading based at least in part on at least one rule associated with the priority of the at least one sensor reading;
transferring the data transmission schedule for the at least one sensor reading to the battery; and
transmitting, by the battery, the at least one sensor reading to the remote server according to the data transmission schedule.

12. The method of claim 10, wherein the priority of the at least one sensor reading is based at least in part on a value of the at least one sensor reading and/or a source of the at least one sensor reading.

13. The method of claim 1, further comprising:
reconfiguring characteristics of outputs of the battery for communication with the battery data ports.

14. The method of claim 10, further comprising:
receiving, from the remote server, updated rules; and
updating the data transmission schedule of the battery based on the updated rules.

15. The method of claim 10, further comprising:
appending a location data to the data transmitted to the remote server, wherein the location data is determined by a location circuit of the battery.

16. A system for providing new network connectivity to a sensing device, the system comprising:
the sensing device comprising:
a battery compartment structured to receive a power source, the battery compartment comprising: a battery interface structured to receive data from the power source and a power connection to receive power; and
one or more sensors; and
a battery comprising:
the power source;
a battery processing unit structured to receive sensor data and network credentials from the sensing device; and
a communications module, the communications module structured to establish a network connection with a remote server using the network credentials and transfer the received sensor data to the remote server,
wherein the battery is configured to fit into the battery compartment of the sensing device.

17. The system of claim 16, wherein the communications module is further structured to interpret a data transmission schedule for transferring data to the remote server.

18. The system of claim 17, wherein the data transmission schedule comprises rules for transmitting data based on a priority of the data.

19. The system of claim 17, wherein the data transmission schedule comprises rules for transmitting data based on values of data obtained from the one or more sensors.

20. The system of claim 16, further comprising a location module structured to determine a location data associated with the battery, and wherein the location data is appended to the received sensor data that is transferred to the remote server.

21.-51. (canceled)
